(19) United States
(12) Patent Application Publication
(10) Pub. No.: US 2025/0362888 A1
(43) Pub. Date: Nov. 27, 2025

(54) PROCESSING AN UNSUPPORTED SIGNAL TYPE, AND CREATING A CONTROL PROGRAM

(71) Applicant: dSPACE GmbH, Paderborn (DE)

(72) Inventor: Michael MAIR, Paderborn (DE)

(21) Appl. No.: 19/212,791

(22) Filed: May 20, 2025

(30) Foreign Application Priority Data
May 22, 2024 (EP) 24177345.6

(51) Int. Cl. G06F 8/34

(52) U.S. Cl. CPC G06F 8/34

(57) ABSTRACT

A method for processing an unsupported signal type in a graphical control model of a development platform includes: storing, by a computer system, a specification containing at least one identifier for a variable of a data type corresponding to an unsupported signal type in a definition database, and when the control program for the target platform is created, using, by the computer system, the data memory object as a representative of the variable via the identifier.

### CROSS-REFERENCE TO PRIOR APPLICATIONS

This application claims benefit to European Patent Application No. EP 24177345.6, filed on May 22, 2024, which is hereby incorporated by reference herein.

### FIELD

The present disclosure relates to a computer-implemented method for processing an unsupported signal type in a graphical control model of a development platform in such a way that a control program for a target platform can be created, and preferably is created, from the graphical control model of the development platform.

In addition, the present disclosure relates to a method for configuring a target platform configured as a controller, in which a control program for the target platform is created from an input graphical control model in accordance with the above method.

In addition, the present disclosure relates to a data processing device configured for carrying out the above method.

The present disclosure further relates to a computer program product comprising commands which, when the program is executed by a computer, cause said computer to carry out the above method.

The present disclosure furthermore relates to a computer-readable data medium on which the above computer program product is stored.

### BACKGROUND

Methods for creating a control program from a graphical control model in a computer-assisted manner have been known for some time and are some of the fundamental functionalities of development environments. In particular, programs for control systems, for example controllers, can thus be built.

The graphical control model is often in the form of a block diagram with the aid of which the mathematical functionality of a control algorithm is modeled and displayed, for example. Via the graphical control model, processes, control devices, and/or generally the response of the controller can first be simulated, and it can be checked whether desired properties are present. The block diagram forming the model generally comprises a plurality of blocks that are connected by signal lines and execute operations such as calculations, it being possible, for example, for a block to calculate an output signal from a plurality of input signals. Signals of different signal types can be transmitted between the blocks via the signal lines, or even via memory areas that are globally accessible for the graphical control model. The graphical control model supports a multiplicity of signal types, for example scalars or matrixes. However, some blocks do not support all possible signal types. In addition, some signal types are not supported by the graphical control model at all.

Generally, block diagrams are executed cyclically, with all the blocks being retained permanently in the memory and each block being executed once per time step. In particular, a block can apply one or more operations to input signals from the last time step in order to create output signals of the current time step. Accordingly, the usual assumptions in relation to control programs, for example a lifetime of variables of the control program, cannot be readily carried over to the graphical control model.

Besides a cyclically executed sub-model for describing the almost continuous-time response of the controller, graphical control models can also comprise a sub-model for describing a discrete response in which a number of states and transitional conditions are defined.

Methods for creating control programs from graphical control models are also referred to as code generators. These are computer programs that translate the graphical control model into source code of the selected target platform, i.e., into the control program. Unlike the graphical control model, the control program is entirely in text form and comprises instructions for execution on the target platform. Code generators thus ensure reliable, error-free implementation of an abstract functional description (graphical control model) in a program for the target platform (control system). The signals of different signal types occurring in the graphical control model are implemented in the control program by variables of different data types.

Code generation usually involves creating a variable in the source code for each output of a block. However, the disadvantage of this is that generally more variables than are actually needed are initially produced. The number of variables, or generally the size of the code, can be reduced by subsequent optimization. In this regard, EP 2 418 577 A1 describes transforming a block diagram into an intermediate representation and applying at least one optimization to this intermediate representation in order to create an optimized intermediate representation. A multiplicity of further optimizations, which are known per se from compiler construction, can be applied successively to create further-optimized intermediate representations. Next, the control program is created from the optimized intermediate representation, preferably in C code. A method for creating a control program is described, for example, in document DE 10 2020 124 080 A1 or document EP 2 916 183 B1.

Control systems such as controllers, in particular those in the automotive industry, are not only subject to technical requirements but also have to meet certain regulatory standards. AUTOSAR (AUTomotive Open System ARchitecture) is a worldwide development partnership involving automotive manufacturers, suppliers, and businesses from the software industry with the goal of developing and mainstreaming standardized software architecture for electronic controllers. To achieve the goal of making the software transferable and scalable to different vehicle designs and platform designs, standards and specifications that the control program of the controllers has to comply with have been and are still being defined. For example, the system configuration description contains information reconciled between different controllers, for example the definition of particular data types. Therefore, it may be that a specific data type is predetermined at control program level, but in the graphical control model there is no corresponding signal type that is supported by the graphical control model.

Furthermore, the graphical control model generally allows for the integration of “custom code blocks”, i.e., blocks that perform operations programmed specifically by the user. It is thus possible that the user uses a specific data type within the custom code block, or the code block corresponding thereto in the control program, but in the graphical control model there is no corresponding signal type that is supported by the graphical control model. Nevertheless, the unsupported signal type has to be processed in order to create the control program from the graphical control model.

### SUMMARY

In an exemplary embodiment, the present disclosure provides a method for processing an unsupported signal type in a graphical control model of a development platform in such a way that a control program for a target platform can be created from the graphical control model of the development platform, the graphical control model comprising a block diagram that has a plurality of blocks and being configured to relay signals of different signal types between at least two blocks, the signal types being implemented by different data types in the created control program, and the graphical control model not supporting all the data types needed in the control program, the graphical control model referencing a definition database in which information relating to the graphical control model is stored, the definition database comprising at least one data memory object, and the data memory object specifying a memory area that is globally accessible for the graphical control model such that the graphical control model is configured to relay signals between two blocks not linked by a signal line. The method includes: storing, by a computer system, a specification containing at least one identifier for a variable of a data type corresponding to an unsupported signal type in the definition database, and when the control program for the target platform is created, using, by the computer system, the data memory object as a representative of the variable via the identifier.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a data processing device according to a preferred embodiment example of the present disclosure,

FIG. 2 schematically shows the software components installed on the device according to FIG. 1,

FIGS. 3 and 4 schematically show a graphical control model used to illustrate a computer-implemented method for processing an unsupported signal type in the graphical control model such that a control program is created, according to a preferred embodiment example of the present disclosure,

FIG. 5 schematically shows a definition database for the graphical control model shown in FIGS. 3 and 4,

FIG. 6A and FIG. 6B schematically show two hierarchically structured graphical control models,

FIG. 7 schematically shows a further graphical control model for explaining the computer-implemented method for processing an unsupported signal type according to a preferred embodiment example of the present disclosure, and

FIG. 8 schematically shows a further graphical control model for explaining the computer-implemented method for processing an unsupported signal type according to a preferred embodiment example of the present disclosure.

### DETAILED DESCRIPTION

Exemplary embodiments of the present disclosure provide measures for improving the processability of unsupported signal types in the graphical control model. Further exemplary embodiments of the present disclosure provide measures for creating a control program from a graphical control model in a simplified manner.

According to the present disclosure, therefore, a computer-implemented method is provided for processing an unsupported signal type in a graphical control model of a development platform in such a way that a control program for a target platform can be created, and preferably is created, from the graphical control model of the development platform, wherein the graphical control model comprises a block diagram having a plurality of blocks and is configured to relay signals of different signal types between at least two blocks, wherein the signal types are implemented by different data types in the created control program, and wherein the graphical control model does not support all the data types needed in the control program, wherein the graphical control model references a definition database in which information relating to the graphical control model is stored, wherein the definition database comprises at least one data memory object, and wherein the data memory object specifies a memory area that is globally accessible for the graphical control model such that the graphical control model is configured to relay signals between two blocks not linked by a signal line. The method is characterized in that a specification containing at least one identifier for a variable of a data type corresponding to an unsupported signal type can be stored in the definition database, and when the control program for the target platform is created, the data memory object is used as a representative of the variable via the identifier.

Since the control program for the target platform is preferably created in a method according to the present disclosure, the method is thus, in other words, preferably also a computer-implemented method for creating the control program for the target platform from the graphical control model of the development platform.

A method according to the present disclosure thus makes use of the data memory object which is present in the definition database and which specifies the memory area that is globally accessible for the graphical control model, and also makes use of the identifier for the variable in the control program, which variable can likewise be stored in the definition database and has a data type for which there is no corresponding signal type in the graphical control model, in order, when creating the control program, to use the data memory object as a representative of the variable via the identifier. At graphical control model level, therefore, the data memory object used as a representative of the variable when the control program is created is transferred from the outside, as it were, i.e., from the globally accessible memory area, to the blocks in which the unsupported signal type is processed. Put another way, it is thus ensured that signals whose signal type is not supported by the graphical control model or which are not permitted in the graphical control model are still used at the right point in the created control program. In the present case, the unsupported signal type includes not only signal types not supported by the graphical control model but also signal types not supported by the code generator for creating the control program.

In other words, therefore, the modeling of the interface with the blocks in which signals having unsupported signal types are processed is not expanded to include the unsupported signal types. Consequently, the processability of unsupported signal types at graphical control model level is improved, and the creation of the control program from the graphical control model is simplified.

In particular, the present method makes it possible to correctly generate the control program, i.e., the source code, from the graphical control model even though the signal type is not supported by the graphical control model and/or by the code generator. To generate the control program, it is not necessary to transmit a definitive description of the unsupported signal type to the code generator. Instead, for code to be generated correctly and automatically, it is sufficient for the definition database to comprise the data memory object and for the identifier stored in the specification in the definition database to be transmitted to the code generator. Since, when the control program is created, the data memory object is used as a representative of the variable of the data type corresponding to the unsupported signal type, it is possible to deal with the signal part that is not supported by the graphical control model and/or the code generator and accordingly not displayable. In other words, the method thus allows a correct control program to be generated despite the information relating to the unsupported signal type being incomplete.

The block diagram of the graphical control model comprises a plurality of blocks and is configured to relay signals between at least two blocks. For this purpose, a first block issues an output signal, which may consist of one value or a plurality of associated values depending on the definition, and a second block receives this signal as its input signal and takes the signal into account when determining its output signal. Signals can be of different types and comprise and/or transport structured or unstructured data types. By way of example, the signal can be configured as a matrix or as a scalar.

The blocks in the block diagram can be atomic, i.e., from the perspective of the surrounding blocks can form a unit in which all the input signals have to be applied at the start of a computing step and all the output signals are present at the end of a computing step. If block diagrams are hierarchical, a multiplicity of blocks in a subordinate layer can describe the structure of one block in a superordinate layer. Hierarchical or composite blocks, even if they are atomic, can comprise a multiplicity of blocks in a subordinate layer.

The signals can, but need not, be relayed via signal lines that interconnect the blocks. In addition, signals can be transmitted between blocks via the memory area that is specified by the data memory object and globally accessible for the graphical control model. Preferably, the globally accessible memory area is a memory area defined by a DataStore memory block in the graphical control model. The memory area specified by the data memory object can be written to by a DataStore write block of the graphical control model and/or be read by a DataStore read block of the graphical control model. In this way, signals can be transferred between blocks without there being a signal line between blocks.

Since a DataStore memory block has a name that uniquely identifies the DataStore memory block hierarchically in lower structures, the access rights to the memory area derive from the hierarchical structure of the graphical control model and the location of the DataStore memory block in the graphical control model relative to the locations of the DataStore write blocks and/or the DataStore read blocks. If the DataStore memory block is located at the uppermost hierarchical layer in the graphical control model, then all the DataStore write blocks and/or DataStore read blocks that appear in the graphical control model and state the name of said DataStore memory block have access to the memory area specified by the DataStore memory block. By contrast, DataStore write blocks and/or DataStore read blocks are invalid if they state a name of a DataStore memory block that is not in the same layer as or in a higher layer than the corresponding DataStore write block and/or DataStore read block in the hierarchy of the graphical control model. In the present case, “globally accessible memory area” means in particular that the memory area specified by the data memory object is accessible for the blocks in which signals of the unsupported signal type are processed. The term “globally accessible memory area” thus does not necessarily imply that the memory area is positioned in the uppermost hierarchical layer of the graphical control model but rather that the memory area is positioned at least in the hierarchical layer that is necessary for the functionality.

The graphical control model references the definition database in which information relating to the graphical control model is stored. In particular, the definition database also comprises the data memory object for specifying the globally accessible memory area and which is used as a representative of the variable of the data type corresponding to the unsupported signal type. In particular, the definition database is configured such that it is possible to store the specification, which comprises at least the identifier for the variable of the data type corresponding to the unsupported signal type. By way of example, the definition database can have a tree structure.

When determining the control program from the graphical control model, the control program is preferably generated in a multi-stage process, and the signals of different signal types occurring in the graphical control model correspond to variables of different data types in the control program. In this process, use is preferably made of the information stored in the definition database, and particularly preferably of the identifier defined in the specification. In the present case, a signal of an unsupported signal type denotes a signal which occurs in the graphical control model and of which the variable in the control program has a data type for which, in the graphical control model, there is no signal type supported by the graphical control model. In addition, the term “unsupported signal type” in the present case means a signal for which the code generator does not know a mapping rule and which is accordingly not supported by the code generator. For example, the unsupported signal type may be a variable-width bus array signal or an “array of buses”. Accordingly, for unsupported signal types, no mapping rules are stored for creating the control program, unlike with supported signal types. However, by explicitly using the data memory object that is stored in the definition database and used as a representative of the variable of the data type corresponding to the unsupported signal type, it is possible to deal with the unknown or non-displayable part of the signal. In particular, the definition database thus comprises the data memory object for specifying the globally accessible memory area, which data memory object is used as a representative of the variable of the data type corresponding to the unsupported signal type.

The control program (also referred to as source code) is preferably entirely in text form and preferably comprises instructions for the controller.

The advantage of the method is thus that the user receives a representation of an object that is not otherwise accessible, i.e., a representation of the signal of the unsupported signal type, and the user can use this representation in a targeted manner for the further specification and modeling. In addition, via the representation, the method makes it possible to generate correct source code without any specific knowledge of the unsupported signal type. In particular, it is thus possible to generate correct source code for graphical control models in which blocks receive signals of the unsupported signal type (consuming blocks) and/or in which blocks output the unsupported signal type (specifying blocks). Since, when the control program is created, the data memory object specifying the memory area that is globally accessible for the graphical control model is used as a representative of the variable, advantage can be taken of the above-described hierarchically structured access rights to the memory area specified by the data memory object, such that correct source code is generated even without a definitive description of the unsupported signal type. In other words, the variable having the data type corresponding to the unsupported signal type is used automatically in the control program portion corresponding to the relevant block.

According to a preferred development of the present disclosure, it is provided that the specification can be stored in a data element in the definition database, and the data memory object is used in the graphical control model as a representative of the data element. The data element in the definition database makes dealing with and/or accessing the specification particularly simple. At graphical control model level, the data memory object acts as a placeholder for the data element, as it were.

In this regard, according to a further development of the present disclosure, it is provided that the specification comprises additional information relating to the access to the data element and/or relating to the relaying of the data element in the graphical control model. For example, it can be specified in the specification that particular blocks in the graphical control model only have read accesses to the data element, or that read and write accesses are granted.

According to another preferred development of the present disclosure, it is preferably provided that the specification comprises additional information specifying a data type of a supported signal type in accordance with which the unsupported signal type behaves. In the present case, the supported signal type comprises not only signal types supported by the graphical control model but also in particular signal types that are supported by the code generator and for which there is thus a corresponding mapping rule. In other words, preferably, not only is the identifier of the variable of the data type corresponding to the unsupported signal type stored in the specification, but so too is a rule regarding how the unsupported signal type behaves. Preferably, a behavior rule is stored in the specification and refers to a signal type supported by the graphical control model and/or specifies the data type thereof. For example, in addition to the identifier, it can also be stored in the specification whether the variable behaves like a scalar, a vector, a matrix, or a bus signal. This simplifies the creation of the control program since the control program is thus created from the graphical control model via the known mapping rules of the supported signal types even when the graphical control model comprises unsupported signal types.

According to another preferred development of the present disclosure, it is provided that the specification comprises additional information specifying the data type, included in the unsupported signal type, of a supported signal type. Preferably, the specification comprises additional information specifying the data type of a member of an unsupported signal type. Particularly when the variable is a structured data type (or “structure”), it is advantageous to designate the members of the structured data type in the specification. In the present case, a structured data type means a group of a plurality of associated pieces of data, although the data need not be all of the same data type; the individual pieces of data can be referred to as “members” of the structured data types. For example, additional information can thus be stored in the specification to the effect that the variable is a structured data type, the structured data type having at least one member that is a vector. Preferably, the specification can also comprise additional information specifying a data type of a supported signal type in accordance with which a member of the structured data type behaves. This thus also makes it possible to process, in the graphical control model signal types in which, signal types in which one part of the data contained in the signal constitutes an unsupported signal type. It is thus also possible to create the control program on the basis of such a graphical control model even though only one part of the data type is known when generating the code. In particular, when creating the program, use can be made of the mapping rule known through the supported signal type.

According to a preferred development of the present disclosure, it is provided that the method for processing the unsupported signal type in the graphical control model comprises the step of storing the specification in the definition database and preferably in the data element. This step can preferably be initiated by a user. Alternatively, this step can be automated via an interface specification or tool chain.

According to another preferred development of the present disclosure, it is provided that the method for processing the unsupported signal type in the graphical control model, and particularly preferably the method for creating the control program for the target platform from the graphical control model of the development platform, comprises the step of retrieving the specification when the control program is created. Thus, use can be made of the identifier of the variable, and preferably of the additional information relating to the variable, and the data memory object can be used as a representative of the variable via the identifier.

As already mentioned, at graphical control model level, the data memory object used as a representative of the variable when the control program is created is therefore transferred from the outside, as it were, i.e., from the globally accessible memory area, to the blocks in which the unsupported signal type is processed. In this respect, and with regard to the created control program, it is provided according to a preferred development of the present disclosure that the block diagram comprises at least one user-specific code block having a user-defined signal type that is not supported in the graphical control model, and/or at least one function block comprising an external function having an unsupported signal type, wherein, when the control program for the target platform is created, the control program is generated in such a way that, by referencing the data memory object,
a) the variable specified via the specification is used in the control program portion corresponding to the user-specific code block via the identifier, and/or
b) the variable specified via the specification is transferred as an argument when the control program portion corresponding to the function block is called.

Particularly preferably, with regard to variant a), in which the graphical control model comprises a user-specific code block (also referred to as a custom code block) in which an unsupported signal type is used, the control program is therefore generated in such a way that the variable is directly used in the control program portion corresponding to the user-specific code block via the identifier. This generates lean code since unnecessary function calls are avoided.

With regard to variant b), in which an external function having an unsupported signal type is integrated in the graphical control model via the function block, the control program is preferably generated in such a way that the variable specified via the specification is transferred as an argument when the control program portion corresponding to the function block is called. This ensures that the variable is also present at the right point, i.e., at the function call, in the created control program. An argument denotes a transfer value that is stated in a function call. This thus ensures that a list of the arguments passed to the function, which is stated during the function call, matches the function signature.

According to another preferred development of the present disclosure, it is provided that the block diagram has a hierarchical structure and comprises at least one first subsystem and at least one second subsystem, wherein the first subsystem is an external subsystem such that the second subsystem is comprised by the first subsystem, wherein the second subsystem comprises at least one code block in which an unsupported signal type is processed, wherein the specification comprises additional information regarding the relaying of the variable represented by the data memory object, and wherein, when the control program for the target platform is created, the control program is generated in such a way that the variable represented by the data memory object is hierarchically passed down as a function parameter from the control program portion corresponding to the first subsystem to the control program portion corresponding to the second subsystem.

When the graphical control model has a hierarchical structure, a multiplicity of blocks in a subordinate layer—the second subsystem in the present case—can describe the structure of one block in a superordinate layer—the first subsystem in the present case. Subsystems can have additional properties such as implementation in a separate function and/or triggering of the execution of the subsystem via a dedicated signal. In subsystems, special blocks can be arranged in order to further specify the properties of the subsystem. In particular, it is provided that the specification comprises additional information regarding the relaying of the variable represented by the data memory object from the first subsystem to the second subsystem such that, at control program level, the variable is passed down as a function parameter. During this passing down, variables and functions of a basic class are reused, and possibly expanded, in a derived class. This makes it possible to build lean code in accordance with the DRY (“Don't Repeat Yourself”) principle or object-oriented programming and to save on resources.

According to another preferred development of the present disclosure, it is provided that the block diagram comprises at least one block in which signals of the unsupported signal type are read out and/or signals of the unsupported signal type are written, and wherein, when the control program for the target platform is created, the control program is generated in such a way that, by referencing the data memory object, a read access and/or a write access to the data type variable specified via the specification is carried out. At graphical control model level, writing to a signal of the unsupported signal type can be made possible, for example by a signal of the unsupported signal type being introduced into the system from outside via an input port block and being written within the system via a DataStore write block which writes to the globally accessible memory area specified by the data memory object. The DataStore write block is an example of a specifying block. Similarly, via a DataStore read block which reads from the globally accessible memory area specified by the data memory object, the signal of the unsupported signal type can be read and relayed to a target outside the system via an output port block. The DataStore read block is an example of a consuming block. In this form, at graphical control model level, reading of the signal and/or writing of the signal, i.e., consumption and specification, can be made possible and the signal can be forwarded to further blocks, without any knowledge of the specific nature of the unsupported signal type. At control program level, this is preferably implemented by carrying out the corresponding read access or write access to the variable, which is specified via the specification and of which the data type corresponds to the unsupported signal type, as part of an access function (or access method) by referencing the data memory object, without needing any specific, detailed knowledge of the unsupported signal type in order to do so. Preferably, the control program is generated in such a way that the write access is implemented as a modification method (or “setter”) and/or the read access is implemented as a retrieval method (or “getter”).

According to a further development of the present disclosure, it is provided that the block diagram comprises at least one first block, the output value of which is an unsupported signal type and is transferred to a second block as an index-defined input value, the second block performing a dynamic selection and/or a dynamic allocation, wherein the definition database comprises a first data memory object and a second data memory object, wherein, when the control program is created, the first data memory object is used as a representative of a first variable that is processed in a control program portion corresponding to the first block, and wherein, when the control program is created, the second data memory object is used as a representative of a second variable that is processed in a control program portion corresponding to the second block, wherein the specification of the second data memory object comprises additional information such that the unsupported signal type processed in the second block behaves like an associative data type comprising a plurality of elements, and the additional information comprises an access rule for accessing an element, wherein, when the control program for the target platform is created, the control program is generated in such a way
that a read access to the first variable represented by the first data memory object is carried out in the control program portion corresponding to the first block, and that a dynamic read and/or write access to an element of the second variable, which is configured as an associative data type and represented by the second data memory object, is carried out in the control program portion corresponding to the second block, and
that the first variable in the control program portion corresponding to the first block is a key that enables access to an element of the second variable, which is configured as an associative data type and is processed in the control program portion corresponding to the second block.

In graphical control models in which a function output, i.e., the output of the first block, returns a pointer or an index that drives the index input for a dynamic selection and/or a dynamic allocation of the second block, the supported signal type is thus extracted out of the signal of the unsupported signal type in the modeling by a dynamic element access, with regard to the dynamic selection and/or the dynamic allocation. The access rule stored in the specification of the second data memory object for the unsupported signal type processed in the second block can be stored as a function or a method in the specification. Said stored function or method is then preferably used when creating the control program.

In the present case, an associative data type means a group of a plurality of associated pieces of data, the data preferably being identically structured. The individual pieces of data are denoted as elements of the associative data type. An element of the associative data type can be numerically accessed via an index of the corresponding element, or via a key for addressing the element. The key may be of any data type (for example a character string) but must uniquely identify the element.

In this regard, it is provided according to another preferred development of the present disclosure that the associative data type is an associative array, and an array element access can be performed using the key. In this case, the access rule stored in the specification of the second data memory object is thus preferably a method for performing an array element access. In an associative array, by contrast with a conventional array, the key may also be non-numerical, for example a character string.

According to an alternative preferred development of the present disclosure, it is provided in this regard that the associative data type specifies one part of the main memory of the target platform, and that the key constitutes an address to the main memory. In other words, the key is a pointer that buffers a memory address and references a main-memory location specified by the address. In the main memory, data such as variables, objects, or program statements can be stored. The acquisition of the data stored therein is referred to as dereferencing.

In relation to the first block of the block diagram, the output value of which is an unsupported signal type, it is preferably provided at control program level that a pointer to void is declared in the control program portion corresponding to the first block. A pointer to void is a pointer in which the type of the data at the address of the main memory referred to by the pointer is not declared. A pointer to void cannot be readily dereferenced, i.e., it is not readily possible to reach the data stored at the address in the main memory. For dereferencing, the pointer to void is preferably first converted into a typed pointer by type conversion. It is accordingly provided in this case that the access rule stored in the specification of the second data memory object is preferably an access rule for performing a type conversion to convert the pointer to void into a typed pointer such that the dynamic read and/or write access to the address of the main memory of the target platform can be performed in the control program portion corresponding to the second block.

According to a preferred development of the present disclosure, creating the control program for the target platform from the graphical control model of the development platform comprises the steps of:
creating an intermediate representation from the graphical control model,
optimizing the created intermediate representation, and
creating the control program for the target platform by translating the optimized intermediate representation,
   wherein at least one of the steps comprises retrieving the identifier of the variable whose data type corresponds to the unsupported signal type, in order to use the data memory object as a representative of the variable.

Therefore, a method for creating the control program for the target platform from the graphical control model of the development platform is preferably provided in which creating the control program comprises transforming the graphical control model into an intermediate representation, preferably successively optimizing the intermediate representation, and translating the optimized intermediate representation into the control program, wherein at least one of the steps is performed in consideration of the specification stored in the definition database such that the identifier of the variable is retrieved. Preferably, the identifier is already retrieved when the intermediate representation is created from the graphical control model. In this way, all the information from the graphical control model is still available.

Preferably, in the intermediate representation the blocks of the block diagram of the graphical control model are translated into statements having a fixed order of execution, as a result of which the structure of the intermediate representation semantically maps a text-based programming language. The transforming step can include a plurality of sub-steps such as checking a number of rules and attaching further code generation information. In principle, the data memory object can be used as a representative of the variable via the identifier in any intermediate step of the transformation, and is preferably used in each transformation step.

According to a further development of the present disclosure, it is provided that the control program is created in C code. In the present case, C code means a programming language that is built on C in terms of syntax and/or underlying language structure. Languages of this kind have, for example, statements terminated by semicolons, code blocks separated by curly brackets, parameters separated by brackets, and/or arithmetic and logical expressions defined in infix notation. In some cases they are also referred to as “curly bracket languages”. In the present case, C code preferably also includes code in the programming language C++, Handel-C, and/or SA-C. More preferably, this means a standardized form of C code such as ANSI C, ANSI C++, ISO C, ISO C++, Standard C, and/or Standard C++, published by the American National Standards Institute (ANSI), ISO/IEC JTC 1/SC 22/WG 14, of the International Organization for Standardization (ISO), and ISO/IEC JTC 1/SC 22/WG 21 of The C++ Standards Committee (ISOCPP) of the International Organization for Standardization (ISO) and/or the International Electrotechnical Commission (IEC).

The present disclosure further relates to a method for configuring a target platform configured as a controller, wherein the target platform comprises at least one arithmetic logic unit and preferably at least one sensor and/or actuator in order to acquire data on a physical process and/or to influence a physical process, comprising the steps of:
inputting a graphical control model of a development platform,
creating a control program for the target platform from the input graphical control model in accordance with the above-described method,
creating a code that is executable for the arithmetic logic unit of the target platform by compiling the created control program,
transmitting the created executable code to the target platform and/or storing the created executable code on a non-volatile memory of the target platform and/or executing the created executable code using the arithmetic logic unit of the target platform.

The controller preferably comprises an interface for connecting to the development platform. More preferably, the controller comprises a microcontroller which has a different architecture from a processor of the development platform, as well as a working memory and a non-volatile memory. More preferably, the controller can also comprise more than one arithmetic logic unit.

The present disclosure further relates to a data processing device configured for carrying out the above-described computer-implemented method for creating the control program.

Particularly preferably, the device comprises a definition database for storing information relating to the graphical control model, and in particular for storing the data memory object and for storing the specification containing at least one identifier and optionally the additional information. The definition database can have a tree structure and/or be stored as a single file in a memory of the device. Alternatively, it can be provided that the specification and the additional information are stored in a dedicated database system.

The present disclosure further relates to a computer program product comprising commands which, when the program is executed by a computer, cause said computer to carry out the above-described computer-implemented method for creating the control program.

The present disclosure furthermore relates to a computer-readable data medium on which the above computer program product is stored.

Preferably, the commands are embedded on the computer-readable data medium and, when the commands are executed by a processor of the computer, they cause the processor to carry out the method for creating the control program.

The technical advantages and effects of the method for configuring the target platform configured as the controller, of the data processing device, of the computer program product, and of the computer-readable data medium become apparent to a person skilled in the art from the description of the method for creating the control program and from the embodiment examples described below.

The present disclosure will be described in more detail below with reference to the drawings. The illustrated embodiments are highly schematic, i.e., the distances and the lateral and vertical dimensions are not true to scale and, unless indicated otherwise, do not have any derivable geometric relationships to each other either.

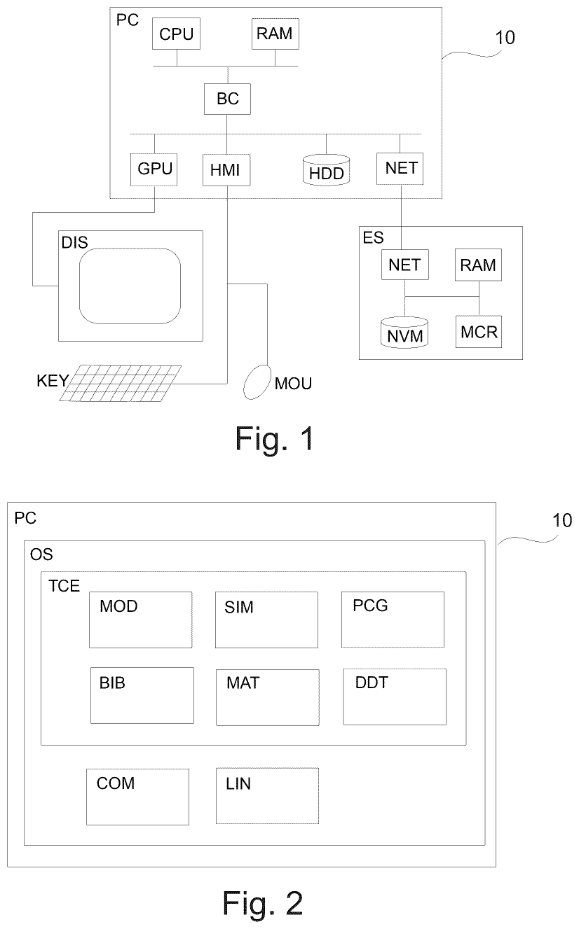

FIG. 1 schematically shows an example configuration of a data processing device 10, which is referred to as a computer system PC in the present case. The computer system PC is configured to carry out a method for creating a control program for a target platform ES from a graphical control model of a development platform, i.e., the computer system. The computer system PC has a processor CPU, which can be implemented in particular as a multi-core processor, as well as a working memory RAM and a bus controller BC. Preferably, the computer system PC is configured to be manually operated by a user, a monitor DIS being connected via a graphics card GPU and a keyboard KEY and a mouse MOU being connected via a human-machine interface HMI. In principle, the human-machine interface of the computer system PC could also be in the form of a touchscreen interface. The computer system PC further comprises a non-volatile data memory HDD, which in particular can be configured as a hard disk and/or a solid-state disk, as well as an interface NET, in particular a network interface. A controller ES, i.e., the target platform ES, can be connected via the interface NET. In principle, one or more interfaces of any kind, in particular wired interfaces, can be provided on the computer system PC and each used for connecting to a controller ES. Expediently, a network interface according to the Ethernet standard can be used; the interface NET can also be configured to be wireless, in particular as a WLAN interface or as per a standard such as Bluetooth.

The controller ES can be configured as a serial controller or an evaluation board for the target platform ES. Expediently, it comprises an interface NET for connecting to the computer system PC, a microcontroller MCR having a different architecture from the processor of the computer system PC, a working memory RAM, and a non-volatile memory NVM.

FIG. 2 shows a diagram of the software components preferably installed on the computer system PC. These use mechanisms of the operating system OS in order, for example, to access the non-volatile memory HDD or to establish a connection to an external computer and/or to the controller ES via the network interface NET.

A technical computing environment TCE allows models, in particular graphical control models 12, to be built, and allows a control program, also referred to as source code, to be created from the graphical control models 12. In a modeling environment MOD, graphical control models 12 of a dynamic system can preferably be built via a graphical user interface. These can in particular be block diagrams that comprise a plurality of blocks 14, 16, 18, 28, 30, 32, 34, 36, 38, 40, 42, 46 and describe the time response and/or the internal states of a dynamic system. At least some of the blocks 14, 16, 18, 28, 30, 32, 34, 36, 38, 40, 42, 46 can be interconnected by signal lines, the signal lines constituting directional connections for exchanging signals of different signal types, the signals being able to be scalar or composite. Operations and/or computing steps to be carried out on the signals can be defined via the blocks 14, 16, 18, 28, 30, 32, 34, 36, 38, 40, 42, 46. In particular, via memory areas that are globally accessible for the graphical control model 12, signals can be relayed between two blocks 14, 16, 18, 28, 30, 32, 34, 36, 38, 40, 42, 46 not linked by a signal line. For this purpose, a definition database DDT comprises a data memory object 20 that specifies the globally accessible memory area.

The computing environment TCE comprises one or more libraries BIB from which blocks or modules for building a model can be selected. In a script environment MAT, statements can be input interactively or via a batch file, in order to perform calculations or modify the model. The computing environment TCE further comprises a simulation environment SIM configured to interpret or execute the block diagram in order to examine the time response of the system. These calculations are preferably carried out using highly accurate floating-point numbers on one or more cores of the microprocessor CPU of the computer system PC.

Via a code generator PCG, the source code can preferably be created from a built model in a programming language such as C. In the created source code, the signal types are implemented by different data types; however, the graphical control model 12 does not support all the data types needed in the control program. To create the source code, the method for creating a control program for a target platform ES from the graphical control model 12 of the development platform is carried out in the present embodiment example. In addition, in the present case, additional information relating to the model 12, in particular a specification containing at least one identifier 22 for a variable of a data type corresponding to an unsupported signal type, is stored in the definition database DDT, and when the source code is created, the data memory object 20 is used as a representative of the variable via the identifier 22.

Furthermore, other additional information relating to the model 12 can also be stored in the definition database DDT, such as information relating to the variables in the blocks (referred to as block variables). Value ranges and/or scales can be assigned to the block variables in order to assist with the calculation of the model using fixed-point instructions. Moreover, desired properties of the source code, for example compliance with a standard such as MISRA, can be set or stored in the definition database DDT. Each block variable can be assigned to a predetermined variable type, and/or one or more desired properties can be set, for example the admissibility of optimizations such as combining variables.

The code generator PCG preferably evaluates the settings of the definition database DDT, and in particular the stored identifier 22, and uses the data memory object 20 when creating the source code via the identifier 22 as a representative of the variable of the data type for which there is no corresponding signal type. The definition database DDT can have a tree structure or be stored as a simple file in a memory of the computer system; alternatively, it can be provided that the definition data are stored in a dedicated database system. The definition database can have a programming interface and/or import/export functions.

In this embodiment example, the computer system PC has a compiler COM and a linker LIN, which expediently are configured for creating binary files that are executable on a controller ES and/or the computer system PC. In principle, there may be a multiplicity of compilers, in particular cross-compilers for different target platforms, in order to support controllers or evaluation boards ES having different processor architectures.

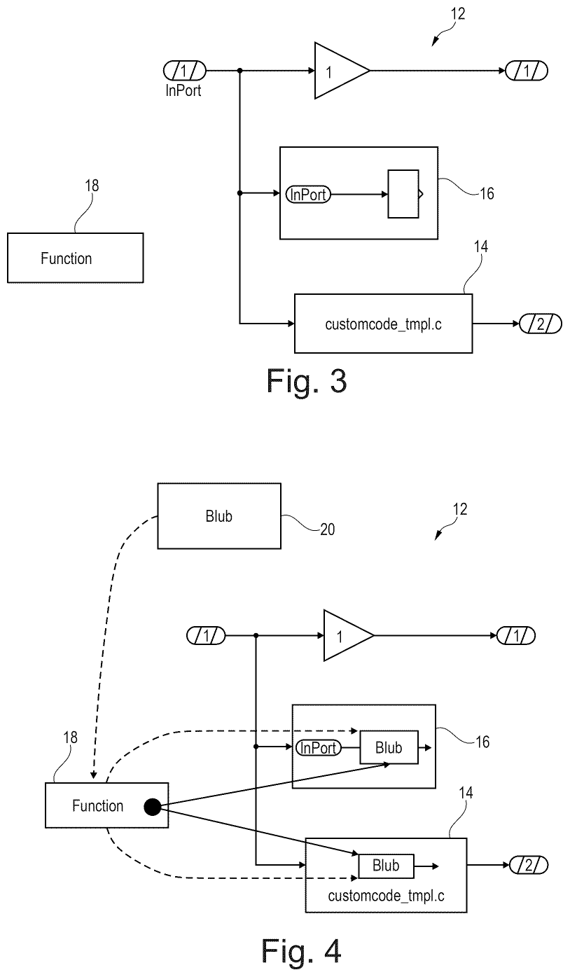

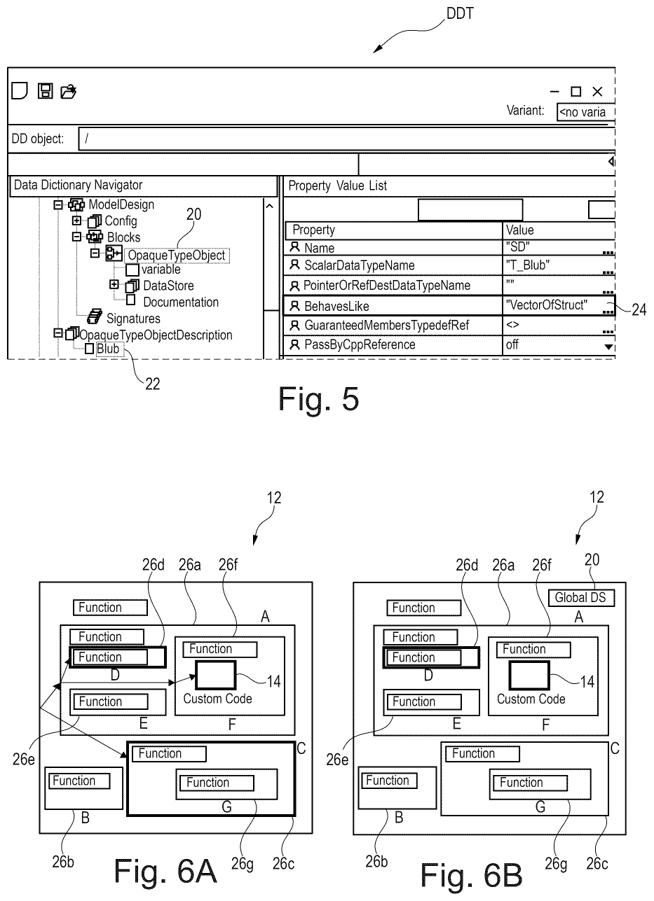

On the basis of an example graphical control model 12 and an example definition database DDT, FIGS. 3 to 5 demonstrate the principle of the computer-implemented method for processing the unsupported signal type in the graphical control model 12 such that the control program is created. FIG. 3 shows an example graphical control model 12 which, in the present case, comprises a user-specific code block 14 having a user-defined, unsupported signal type, and a function block 16 comprising an external function having an unsupported signal type. Therefore, in the blocks 14 and 16, there is code whose content is not fully known. To expand the interface in the code to include the unsupported signal type, an object 18 having the unsupported signal type should be transferred from the outside as a function parameter. In the context of the present embodiment example and with reference to FIGS. 4 and 5, this is implemented as follows:

The definition database DDT (shown schematically in FIG. 5) comprises a data memory object 20 specifying a memory area that is globally accessible for the graphical control model 12 such that the graphical control model 12 is configured to relay signals between two blocks not linked by a signal line-block 18 and block 16, and block 18 and block 14, in the present case. In addition, a specification containing at least one identifier 22 for a variable of a data type corresponding to an unsupported signal type is stored in the definition database DDT. In the present case, the identifier is “Blub”.

When the control program for the target platform is created, the data memory object 20 is used as a representative of the variable via the identifier 22, as shown schematically on the basis of arrows in FIG. 4. At the level of the graphical control model 12, therefore, the data memory object 20 used as a representative of the variable when the control program is created is transferred from the outside, i.e., from the globally accessible memory area, to the blocks 14, 16 in which the unsupported signal type is processed.

At control program level, the following example source code is generated for the user-specific code block 14 and the function block 16 comprising an external function, said source code illustrating the use of the data memory object 20 as a representative of the variable via the identifier 22 (“Blub” in the present case):

```
Foo (int16_t In1, T_Blub* Blub)
{
  ExternalFunction(In1, Blub);
  /* Custom Code: output section */
  {
  ... Blub...
  }
}
```

When the control program portion corresponding to the function block is called, the variable specified via the specification is thus transferred as an argument—ExternalFunction(In1, Blub)—whereas in the control program portion corresponding to the user-specific code block, the variable specified via the specification is used directly as the identifier— . . . Blub.

In the example definition database in FIG. 5, it can also be seen that the specification comprises additional information 24 specifying a data type of a supported signal type in accordance with which the unsupported signal type behaves. In the present case, it is specified that the unsupported signal type behaves like a vector of a structure (VectorOfStruct).

FIGS. 6A and 6B schematically illustrate the propagation across subsystem limits in a hierarchically structured graphical control model 12. In FIG. 6A and FIG. 6B, the graphical control model 12 is in principle constructed in the same way and comprises a plurality of subsystems 26A, 26B, 26C, 26D, 26E, 26F, the subsystem 26A being an external subsystem in relation to the subsystems 26D, 26E, 26F since the subsystems 26D, 26E, 26F are covered by the subsystem 26A. Likewise, the subsystem 26C is an external subsystem in relation to the subsystem 26G.

In the example in FIG. 6A, the subsystems 26D and 26C have code blocks in which an unsupported signal type is processed. In addition, the subsystem 26F has a user-specific code block 14 in which an unsupported signal type is processed.

Since the specification stored in the definition database DDT comprises additional information regarding the relaying of the variable (denoted by the identifier “pAdditional” in the present case) represented by the data memory object, and since, when the control program for the target platform is created, the control program is generated in such a way that the variable represented by the data memory object 20 is passed down hierarchically as a function parameter from the control program portion corresponding to the first subsystem 26A to the control program portion corresponding to the second subsystem 26D, 26E, 26F, the following code is generated for the example in FIG. 6A:

```
Root(OpaqueType* pAdditional)
{
  A(pAdditional); /* not directly marked, propagation */ B( );
  C(pAdditional); /* directly marked */
}
A(OpaqueType* pAdditional)
{
  D(pAdditional); /* directly marked */
  E( );
  F(pAdditional); /* not directly marked, propagation */
}
C(OpaqueType* pAdditional)
{
  G( ); /* No propagation */
}
```

For the example shown in FIG. 6B, in which the subsystem 26D has a code block in which an unsupported signal type is processed and the subsystem 26F has a user-specific code block 14 in which an unsupported signal type is processed, the following code is generated on the basis of the global memory area present at the hierarchical layer of the subsystem of 26A and specified by the data memory object 20:

```
#include “OpaqueTypeVariables.h”
Root( )
{ /* Data Store Memory Block inside, no additional parameter */
  A(&Additional); /* not directly marked, propagation */
  B( );
  C( );
}
A(OpaqueType* pAdditional)
{
  D(pAdditional); /* directly marked */
  E( );
  F(pAdditional); /* not directly marked, propagation */
}
```

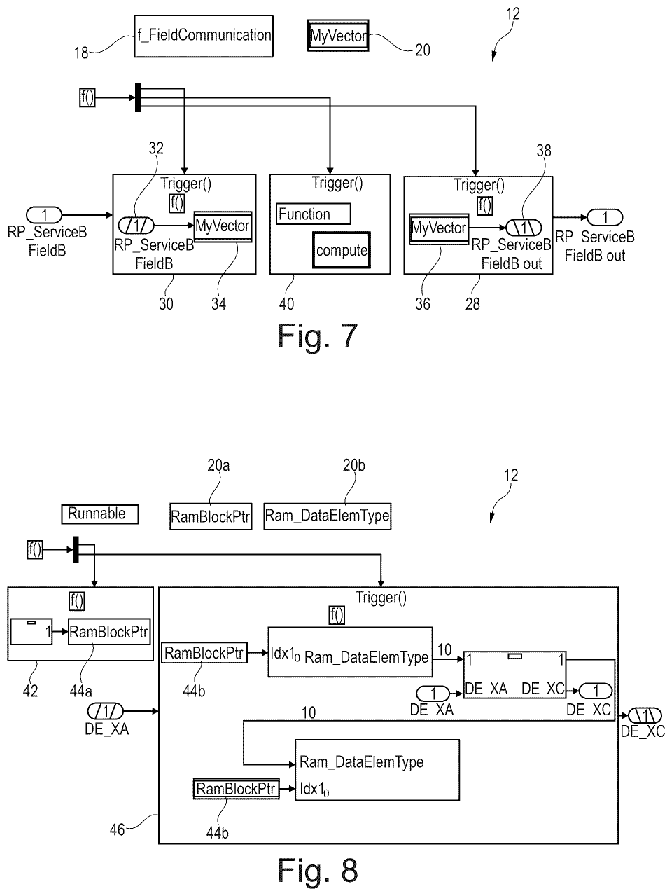

With reference to FIG. 7, it is illustrated on the basis of another embodiment example how the method for creating the control program processes the unsupported signal type. FIG. 7 schematically shows a further graphical control model 12 which, in the present case, comprises a block 28 in which signals of the unsupported signal type are read out, and a block 30 in which signals of the unsupported signal type are written. In the present embodiment example, the variable of the data type corresponding to the unsupported signal type is stored in the definition database as the identifier “FieldB”.

At the level of the graphical control model 12, writing to the signal “My Vector” of the unsupported signal type is made possible by a signal of the unsupported signal type being introduced into the system from outside via an input port block 32 and being written within the system via a DataStore write block 34 which writes to the globally accessible memory area specified by the data memory object 20, which is configured as a DataStore memory block. In the present case, the read access is implemented via a DataStore read block 36, which reads from the globally accessible memory area specified by the data memory object 20 and relays the signal of the unsupported signal type to a target outside the system via an output port block 38. In addition, FIG. 7 shows that the block 40 in which the unsupported signal type is processed can access the signal.

When the control program for the target platform is created, the control program is generated in such a way that a read access and a write access to the data type variable specified via the specification are carried out by referencing the data memory object 20, with the following example code being created:

```
void f_FieldCommunication(void)
{
  dspace::targetlink::vectorOfStruct FieldB;
  Get_AdaptiveSwc_RP_ServiceB_FieldB_NoServiceDiscovery_S1(FieldB);
  compute(FieldB);
  Set_AdaptiveSwc_RP_ServiceB_FieldB_NoServiceDiscovery_S1(FieldB);
}
```

Therefore, in the source code, the write access to the variable “FieldB” is implemented as a setter and the read access to the variable “FieldB” is implemented as a getter, without any specific, detailed knowledge of the unsupported signal type “My Vector”.

With reference to FIG. 8, it is illustrated on the basis of another embodiment example how the method for creating the control program processes the unsupported signal type. FIG. 8 schematically shows a further graphical control model 12, which in the present case is constructed as follows:

The block diagram comprises a first block 42, the output value 44a of which is an unsupported signal type and is transferred to a second block 46 as an index-defined input value 44b, said second block performing a dynamic selection and a dynamic allocation. As can be seen in FIG. 8 on the basis of the two DataStore memory blocks 20a, 20b, the definition database comprises a first data memory object 20a and a second data memory object 20b, wherein, when the control program is created, the first data memory object 20a is used as a representative of a first variable processed in a control program portion corresponding to the first block 42, and the second data memory object 20b is used as a representative of a second variable processed in a control program portion corresponding to the second block 46. In the present case, the first variable has the identifier “RamBlockPtr”. The specification of the second data memory object 20b further comprises additional information such that the unsupported signal type processed in the second block 46 behaves like an associative data type comprising a plurality of elements and furthermore has an access rule for accessing an element.

When creating the control program for the target platform, the control program is generated in such a way
that a read access to the first variable represented by the first data memory object 20a—“RamBlockPtr”—is carried out in the control program portion corresponding to the first block 42, and that a dynamic read and write access to an element of the second variable, which is configured as an associative data type and represented by the second data memory object 20b, is carried out in the control program portion corresponding to the second block 46, and
that the first variable in the control program portion corresponding to the first block 42 is a key that enables access to an element of the second variable, which is configured as an associative data type and is processed in the control program portion corresponding to the second block 46.

In the present example, the second variable configured as an associative data type and represented by the second data memory object 20b specifies one part of the main memory of the target platform. In the present embodiment example, the key, i.e., the first variable, constitutes an address to the main memory, i.e., a pointer.

In the control program portion corresponding to the first block 42, therefore, the following code is generated, in which a pointer to void is declared:

void* RamBlockPtr;
RWBGetRamBlockPtr(&RamBlockPtr);

Furthermore, it is provided that the access rule stored in the specification of the second data memory object 20b is preferably an access rule for performing a type conversion to convert the pointer to void into a typed pointer such that the dynamic read and write access to the address of the main memory of the target platform ES is performed in the control program portion corresponding to the second block 46 as follows:

```
const sint16* pContents_Read; /* points to sint16[10] /*
sint16 OperationOut[10];
sint16* pContents_Write; /* points to sint16[10] /*
pContents_Read = (const sint16*) RamBlockPtr;
Rte_Read_MyReceiverPort_DE_XA(&DE_XA);
Rte_Call_SomeOperation(pContents_Read, DE_XA, OperationOut);
pContents_Write = (sint16*) RamBlockPtr;
for (I = 0; i< 10; i++) {
  pContents_Write[i] = OperationOut[i];
  }
Rte_Write_MySenderPort_DE_XC(&DE_XC);
```

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Data processing device
12 Graphical control model
14 User-specific code block
16 Function block comprising external function
18 Block
20 Data memory object
22 Identifier
24 Additional information
26 Subsystems
28 Block in which the unsupported signal type is read out
30 Block in which the unsupported signal type is written
32 Input port block
34 DataStore write block
36 DataStore read block
38 Output port block
40 Block in which the unsupported signal type is processed
42 Block whose output value is the unsupported signal type
44a Output value
44b Input value
46 Block whose input value is the unsupported signal type
PC Computer system
CPU Processor
RAM Working memory
BC Bus controller
GPU Graphics card
DIS Monitor
HMI Peripheral interface
KEY Keyboard
MOU Mouse
HDD Non-volatile data memory
NET Interface, network interface
ES Controller
MCR Microcontroller
NVM Memory
OS Operating system
TCE Technical computing environment
MOD Modeling environment
BIB Library
MAT Script environment
SIM Simulation environment
PCT Code generator
DDT Definition data pool
COM Compiler

1. A computer-implemented method for processing an unsupported signal type in a graphical control model of a development platform in such a way that a control program for a target platform can be created from the graphical control model of the development platform,
the graphical control model comprising a block diagram that has a plurality of blocks and being configured to relay signals of different signal types between at least two blocks,
the signal types being implemented by different data types in the created control program, and the graphical control model not supporting all the data types needed in the control program,
the graphical control model referencing a definition database in which information relating to the graphical control model is stored,
the definition database comprising at least one data memory object,
the data memory object specifying a memory area that is globally accessible for the graphical control model such that the graphical control model is configured to relay signals between two blocks not linked by a signal line,
the method comprising:
storing, by a computer system, a specification containing at least one identifier for a variable of a data type corresponding to an unsupported signal type in the definition database, and
upon the control program for the target platform being created, using, by the computer system, the data memory object as a representative of the variable via the identifier.

2. The method according to claim 1, wherein the specification is storable in a data element in the definition database, and the data memory object is used in the graphical control model as a representative of the data element.

3. The method according to claim 2, wherein the specification comprises additional information regarding the access to the data element and/or the relaying of the data element in the graphical control model.

4. The method according to claim 1, wherein the specification comprises additional information specifying a data type of a supported signal type in accordance with which the unsupported signal type behaves; and/or
wherein the specification comprises additional information specifying the data type, included in the unsupported signal type, of a supported signal type.

5. The method according to claim 1, wherein the specification is retrieved when the control program is created.

6. The method according to claim 1, wherein the block diagram comprises at least one user-specific code block containing a user-defined signal type that is not supported in the graphical control model; and/or
wherein the block diagram comprises at least one function block comprising an external function having an unsupported signal type.

7. The method according to claim 6, wherein, when the control program for the target platform is created, the control program is generated in such a way that, by referencing the data memory object,
a) the variable specified via the specification is used in the control program portion corresponding to the user-specific code block via the identifier, and/or
b) the variable specified via the specification is transferred as an argument when the control program portion corresponding to the function block is called.

8. The method according to claim 1, wherein the block diagram has a hierarchical structure and comprises at least one first subsystem and at least one second subsystem, wherein the first subsystem is an external subsystem such that the second subsystem is comprised by the first subsystem,
wherein the second subsystem comprises at least one code block in which an unsupported signal type is processed,
wherein the specification comprises additional information regarding the relaying of the variable represented by the data memory object, and
wherein, when the control program for the target platform is created, the control program is generated in such a way that the variable represented by the data memory object is hierarchically passed down as a function parameter from the control program portion corresponding to the first subsystem to the control program portion corresponding to the second subsystem.

9. The method according to claim 1, wherein the block diagram comprises at least one block in which signals of the unsupported signal type are read out and/or signals of the unsupported signal type are written, and
wherein, when the control program for the target platform is created, the control program is created in such a way that, by referencing the data memory object, a read access and/or a write access to the data type variable specified via the specification is/are carried out.

10. The method according to claim 1, wherein the block diagram comprises at least one first block, the output value of which is an unsupported signal type and is transferred to a second block as an index-defined input value, said second block performing a dynamic selection and/or a dynamic allocation,
wherein the definition database comprises a first data memory object and a second data memory object,
wherein, when the control program is created, the first data memory object is used as a representative of a first variable processed in a control program portion corresponding to the first block, and
wherein, when the control program is created, the second data memory object is used as a representative of a second variable processed in a control program portion corresponding to the second block,
wherein the specification of the second data memory object comprises additional information such that the unsupported signal type processed in the second block behaves like an associative data type comprising a plurality of elements and the additional information comprises an access rule for accessing an element,
wherein, when the control program for the target platform is created, the control program is generated in such a way that:
a read access to the first variable represented by the first data memory object is carried out in the control program portion corresponding to the first block, and a dynamic read and/or write access to an element of the second variable, which is configured as an associative data type and represented by the second data memory object, is carried out in the control program portion corresponding to the second block, and
the first variable in the control program portion corresponding to the first block is a key that enables access to an element of the second variable, which is configured as an associative data type and is processed in the control program portion corresponding to the second block.

11. The method according to claim 10, wherein the associative data type is an associative array, and an array element access can be performed using the key.

12. The method according to claim 10, wherein the associative data type specifies one part of the main memory of the target platform, and wherein the key constitutes an address to the main memory.

13. The method according to claim 1, wherein creating the control program for the target platform from the graphical control model of the development platform comprises the steps of:
creating an intermediate representation from the graphical control model,
optimizing the created intermediate representation, and
creating the control program for the target platform by translating the optimized intermediate representation, and
wherein at least one of the steps comprises retrieving the identifier of the variable whose data type corresponds to the unsupported signal type, in order to use the data memory object as a representative of the variable.

14. A method for configuring a target platform configured as a controller, wherein the target platform comprises at least one arithmetic logic unit and preferably at least one sensor and/or actuator in order to acquire data on a physical process and/or to influence a physical process, comprising the steps of:
inputting a graphical control model of a development platform,
creating a control program for the target platform from the input graphical control model in accordance with the method according to claim 1,
creating a code that is executable for the arithmetic logic unit of the target platform by compiling the created control program, and
transmitting the created executable code to the target platform and/or storing the created executable code on a non-volatile memory of the target platform and/or executing the created executable code using the arithmetic logic unit of the target platform.

15. A data processing device comprising a processor and a memory, wherein the processor is configured to execute instructions stored on the memory to carry out the method according to claim 1.

16. A data processing device comprising a processor and a memory, wherein the processor is configured to execute instructions stored on the memory to carry out the method according to claim 14.

17. A non-transitory computer-readable medium having processor-executable instructions stored thereon for processing an unsupported signal type in a graphical control model of a development platform in such a way that a control program for a target platform can be created from the graphical control model of the development platform,
the graphical control model comprising a block diagram that has a plurality of blocks and being configured to relay signals of different signal types between at least two blocks,
the signal types being implemented by different data types in the created control program, and the graphical control model not supporting all the data types needed in the control program,
the graphical control model referencing a definition database in which information relating to the graphical control model is stored,
the definition database comprising at least one data memory object,
the data memory object specifying a memory area that is globally accessible for the graphical control model such that the graphical control model is configured to relay signals between two blocks not linked by a signal line,
the processor-executable instructions, when executed, facilitating performance of the following:
storing, by a computer system, a specification containing at least one identifier for a variable of a data type corresponding to an unsupported signal type in the definition database, and
when the control program for the target platform is created, using, by the computer system, the data memory object as a representative of the variable via the identifier.

18. A non-transitory computer-readable medium having processor-executable instructions stored thereon, wherein the processor-executable instructions, when executed, facilitate performance of the method according to claim 9.
